(19) United States
(12) Patent Application Publication
(10) Pub. No.: US 2008/0252818 A1
(43) Pub. Date: Oct. 16, 2008

(54) LIQUID CRYSTAL DISPLAY AND BACKLIGHT MODULE THEREOF

(75) Inventors: Zhao-Hui Wu, Taoyuan County (TW); Chih-Li Chang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HANNSTAR DISPLAY CORPORATION, Tao-Yuan Hsien (TW)

(21) Appl. No.: 11/759,936

(22) Filed: Jun. 8, 2007

(30) Foreign Application Priority Data
Apr. 14, 2007 (TW) 96113182

(51) Int. Cl. G02F 1/13357; F21V 8/00

(52) U.S. Cl. 349/65; 362/612; 362/613; 362/616

(57) ABSTRACT

A backlight module including a frame, a plurality of light guide plates, a plurality of high refractive mediums, and a plurality of light sources is provided. The light guide plates are disposed within the frame and each of the light guide plates has at least one light incident surface and at least one light emitting surface. Additionally, high refractive mediums are disposed between two neighboring light guide plates. Moreover, the light sources are disposed beside the light incident surfaces of the light guide plates.

### CROSS-REFERENCE TO RELATED APPLICATION

This application claims the priority benefit of Taiwan application serial no. 96113182, filed Apr. 14, 2007. All disclosure of the Taiwan application is incorporated herein by reference.

### BACKGROUND OF THE INVENTION

1. Field of the Invention

The present invention relates to a display and a backlight module thereof. More particularly, the present invention relates to a liquid crystal display having a plurality of light guide plate structures and a backlight module thereof.

2. Description of Related Art

Generally, a liquid crystal display panel in a display does not luminesce. Therefore, a backlight module is usually disposed under the liquid crystal display panel to provide a planar light source for displaying images. To further improve display quality, scan backlight modules have been developed and become available in the market.

Specifically, a scan backlight module is primarily formed by a plurality of light guide plates and a plurality of light sources. Herein, the light emitted by the light sources passes through the light guide plate and is transmitted to the liquid crystal display panel to provide the light required for the liquid crystal display panel to display images. It should be noted that the light guide plates are arranged by leaning against one another. When the light emitted by the light sources passes through a medium of high refractive index into a medium of low refractive index, total reflection is very likely to occur. Hence, uneven distribution of light or even obvious dark fringes may be produced at the junction between two neighboring light guide plates. As a result, the images displayed by such a liquid crystal display are adversely affected.

### SUMMARY OF THE INVENTION

The present invention is directed to a backlight module that provides even distribution of light.

The present invention is directed to a backlight module including a frame, a plurality of light guide plates, a plurality of high refractive mediums, and a plurality of light sources. Herein, the light guide plates are disposed within the frame, and each light guide plate has at least one light incident surface and one light emitting surface. Further, the high refractive mediums are respectively disposed at the junction between two neighboring light guide plates. Additionally, the refractive index of the high refractive mediums is higher than that of the light guide plates. Moreover, the light sources are respectively disposed beside the light incident surfaces of the light guide plates, and the light emitted by each light source is suitable for entering the light incident surface and being emitted out from the light emitting surface.

In one embodiment of the present invention, the refractive index of the high refractive mediums is at least greater than 1.49.

In one embodiment of the present invention, the material of the high refractive mediums is, for example, a high molecular polymer.

In one embodiment of the present invention, the thickness of the medium disposed between two neighboring light guide plates is between 0.01 mm and 2 mm.

In one embodiment of the present invention, each light guide plate has two light incident surfaces that are opposite to each other, and the light sources are respectively disposed beside the light incident surfaces.

In one embodiment of the present invention, the light source includes a plurality of light emitting diodes (LEDs).

In one embodiment of the present invention, the light emitting diodes include a red light LED.

In one embodiment of the present invention, the light emitting diodes include a green light LED.

In one embodiment of the present invention, the light emitting diodes include a blue light LED.

In one embodiment of the present invention, the light emitting diodes include a red light LED, a green light LED, a blue light LED, or any combination thereof.

The present invention is directed to a liquid crystal display that includes the above-mentioned backlight module and a liquid crystal display panel. Herein, the liquid crystal display panel is disposed on the light emitting surfaces of the light guide plates.

According to the present invention, the high refractive medium disposed at the junction between the two neighboring light guide plates has a refractive index that is higher than that of the light guide plates. Therefore, the backlight module of the present invention can prevent the occurrence of total reflection at the junction between two neighboring light guide plates in order to provide even distribution of light. The backlight module of the present invention is utilized in the liquid crystal display of the present invention to provide good display quality.

In order to make the aforementioned and other objects, features and advantages of the present invention more comprehensible, preferred embodiments accompanied with figures are described in detail below.

### BRIEF DESCRIPTION OF THE DRAWINGS

FIG. 1A is a schematic view illustrating the backlight module of the present invention.

FIG. 1B is an enlarged partial view illustrating the backlight module of the present invention.

FIG. 2A is a graph illustrating the light intensity at the junction between two neighboring light guide plates when no high refractive medium is disposed thereon.

FIG. 2B is a graph illustrating the light intensity at the junction between two neighboring light guide plates when high refractive mediums are disposed thereon.

FIG. 3 is a schematic view illustrating the liquid crystal display of the present invention.

### DESCRIPTION OF EMBODIMENTS

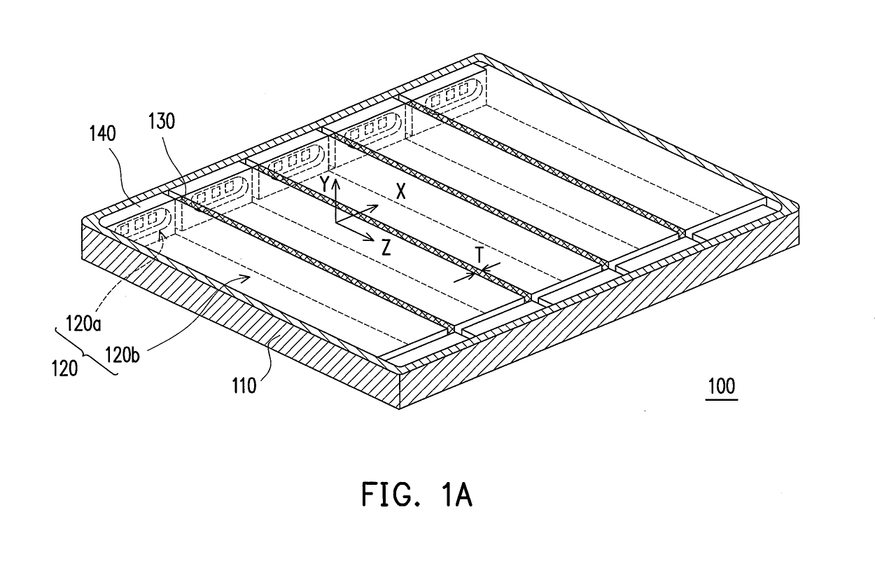

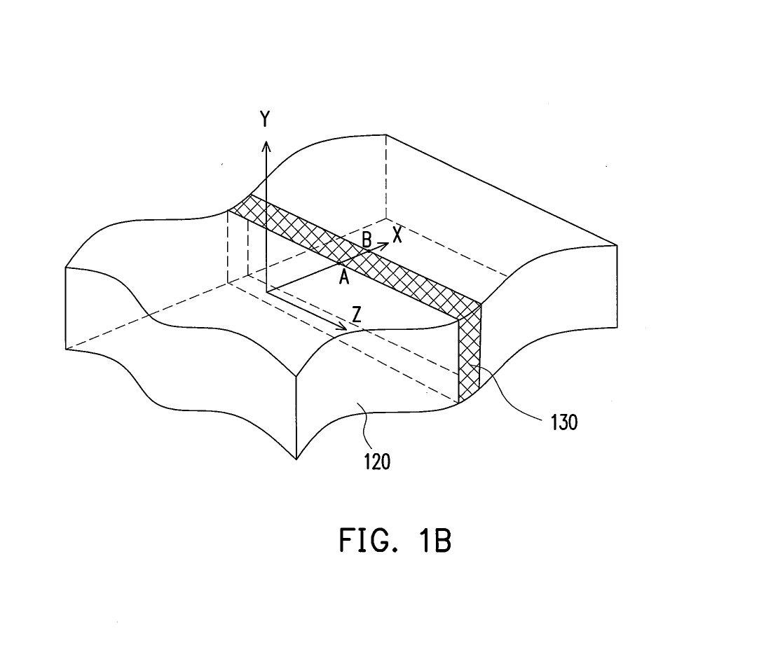

FIG. 1A is a schematic view illustrating the backlight module of the present invention. Please refer to FIG. 1A. In this embodiment, a backlight module 100 includes a frame 110, a plurality of light guide plates 120, a plurality of high refractive mediums 130, and a plurality of light sources 140. Herein, the light guide plates 120 are disposed within the frame 110, and each light guide plate 120 has at least one light incident surface 120a and one light emitting surface 120b. As shown in FIG. 1A, each light guide plate 120 may has two light incident surfaces 120a that are opposite to each other and one light emitting surface 120b. Certainly, those skilled in the art should know that the light guide plate 120 shown in FIG. 1A is merely an example for illustration and the present invention is not limited to the types of the light guide plate 120.

Further, the high refractive mediums 130 are respectively disposed between two neighboring light guide plates 120. It should be noted that the refractive index of the high refractive mediums 130 is higher than that of the light guide plates 120. In practice, the refractive index of the high refractive mediums 130 is at least greater than 1.49. Specifically, the high refractive mediums 130 may be selected from a high refractive index colloid and this colloid may be, for example, a transparent liquid or solid high molecular polymer. Further, the light guide plates 120 may be fabricated by injecting acrylic compounds into molds. Certainly, the shape of the light guide plates 120 may be adjusted as desired by injection molding.

More specifically, the thickness T of the high refractive medium 130 disposed at the junction between two neighboring light guide plates is, for example, between 0.01 mm and 2 mm. Moreover, the light sources 140 are respectively disposed beside the light incident surfaces 120a of the light guide plates 120, and the light emitted by each light source 140 is suitable for entering the light incident surface 120a and being emitted out from the light emitting surface 120b. Specifically, the light sources 140 may include a plurality of light emitting diodes (LEDs). Herein, the light emitting diodes of the light sources 140 may include a red light LED, a green light LED, a blue light LED, or any combination thereof. Certainly, the light emitting diodes may be monochromatic LEDs and the present invention is not limited thereto. Further, in other embodiments, light sources 140 may be other types of light sources such as electroluminescent lights.

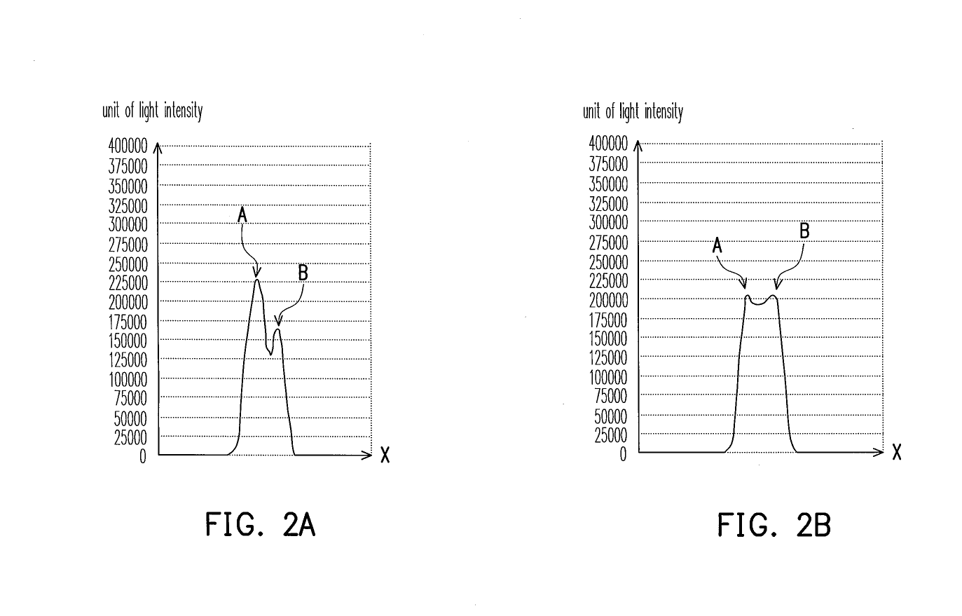

FIG. 1B is an enlarged partial view illustrating the backlight module of the present invention. Please refer to FIG. 1B. It should be noted that since light passes through a medium of high refractive index into a medium of low refractive index, total reflection is likely to occur. Hence, uneven distribution of light is produced at the junction between two neighboring light guide plates (e.g. between point A and point B in FIG. 1B). Specifically, before the high refractive mediums 130 are disposed at the junction between two neighboring light guide plates 120, uneven distribution of light is resulted at the junction between the two neighboring light guide plates 120. As shown in FIG. 2A, light intensity distribution varies greatly from point A to point B. By comparison, in the present invention, after the high refractive mediums 130 are disposed at the junction between two neighboring light guide plates 120, light intensity distribution at point A and that at point B are rather close. It is because the refractive index of the high refractive mediums 130 is higher than that of the light guide plates 120, preventing the occurrence of total reflection at the junction between two neighboring light guide plates 120. As a result, the backlight module can effectively improve the uneven distribution of light at the junction between two light guide plates 120 and greatly enhance the luminescence of the backlight module 100. Further, it should be noted that even though a scan backlight module is used as an example for illustrating an embodiment of the present invention, the application of the present invention is not limited thereto. For example, the backlight module of the present invention can be applied to any backlight module having a plurality of light guide plate structures.

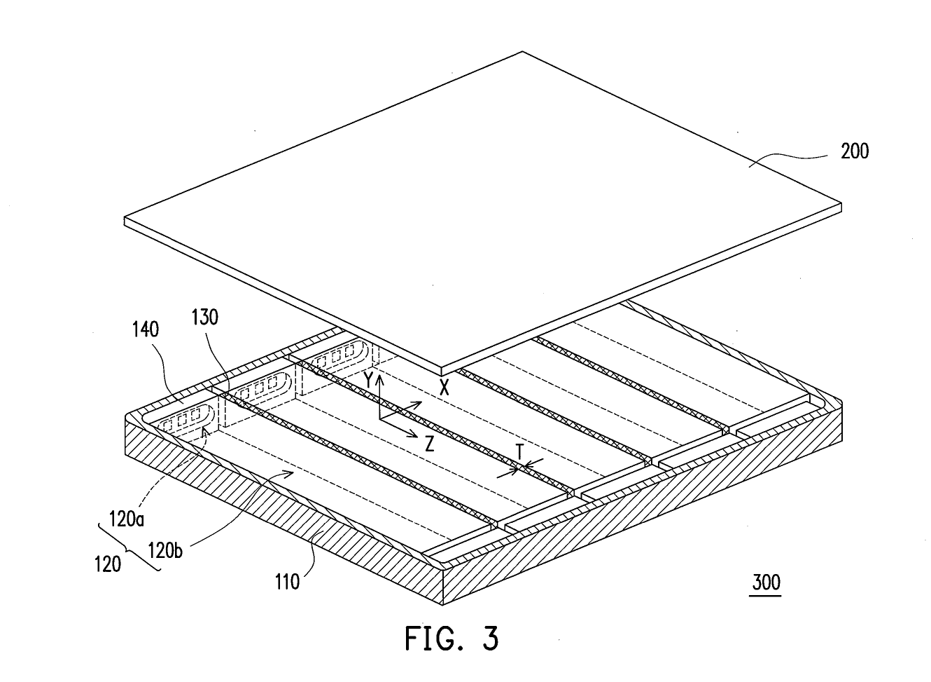

FIG. 3 is a schematic view illustrating the liquid crystal display of the present invention. Please refer to FIG. 3. A liquid crystal display 300 includes a backlight module 100 and a liquid crystal display panel 200. Herein, a backlight module 100 is disposed under the liquid crystal display panel 200 to provide light to the liquid crystal display panel 200 for displaying images. Since the backlight module 100 of the present invention can effectively provide a high-quality planar light source, the display quality of the liquid crystal display can be further improved.

According to the present invention, the high refractive medium between the two neighboring light guide plates has a refractive index that is higher than that of the light guide plates. Therefore, the backlight module of the present invention can prevent the occurrence of total reflection at the junction between two neighboring light guide plates in order to provide even distribution of light. Further, the backlight module of the present invention is applied to the liquid crystal display of the present invention to ensure good display quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A backlight module, comprising:
a frame;
a first light guide plate and a second light guide plate disposed within the frame, wherein each light guide plate has at least one light incident surface and one light emitting surface; and
a high refractive medium disposed between the first light guide plate and the second light guide plate, wherein the refractive index of the high refractive medium is higher than the refractive index of the two light guide plates.

2. The backlight module of claim 1, further comprising at least two light sources respectively disposed beside the light incident surfaces of the two light guide plates.

3. The backlight module according to claim 1, wherein the refractive index of the high refractive medium is at least greater than 1.49.

4. The backlight module of claim 1, wherein the material of the high refractive medium is a high molecular polymer.

5. The backlight module of claim 1, wherein the thickness of the high refractive medium is between 0.01 mm and 2 mm.

6. The backlight module of claim 1, wherein the light sources comprise a plurality of light emitting diodes (LEDs).

7. The backlight module of claim 6, wherein the light sources comprise a red light LED.

8. The backlight module of claim 6, wherein the light sources comprise a green light LED.

9. The backlight module of claim 6, wherein the light sources comprise a blue light LED.

10. The backlight module of claim 6, wherein the light emitting diodes comprise a red light LED, a green light LED, and a blue light LED or any combination thereof.

11. A liquid crystal display, comprising:
a backlight module, comprising:
a frame;
a first light guide plate and a second light guide plate disposed within the frame, wherein each light guide plate has at least one light incident surface and one light emitting surface;
a high refractive medium disposed between the first light guide plate and the second light guide plate, wherein the refractive index of the high refractive medium is higher than the refractive index of the two light guide plates; and
a liquid crystal display panel disposed on the light emitting surface of the two light guide plates.

12. The liquid crystal display of claim 11, further comprising at least two light sources respectively disposed beside the light incident surface of the two light guide plates.

13. The liquid crystal display of claim 11, wherein the refractive index of the high refractive medium is at least greater than 1.49.

14. The liquid crystal display of claim 11, wherein the material of the high refractive medium is a high molecular polymer.

15. The liquid crystal display of claim 11, wherein the thickness of the high refractive medium is between 0.01 mm and 2 mm.

16. The liquid crystal display of claim 11, wherein the light sources comprise a plurality of light emitting diodes.

17. The liquid crystal display of claim 16, wherein the light emitting diodes comprise a red light LED.

18. The liquid crystal display of claim 16, wherein the light emitting diodes comprise a green light LED.

19. The liquid crystal display of claim 16, wherein the light emitting diodes comprise a blue light LED.

20. The liquid crystal display of claim 16, wherein the light emitting diodes comprise a red light LED, a green light LED, and a blue light LED or any combination thereof.
